(19) United States
(12) Patent Application Publication
(10) Pub. No.: US 2024/0314479 A1
(43) Pub. Date: Sep. 19, 2024

(54) EMBEDDED WATERPROOF MEMBRANE

(71) Applicant: Apple Inc., Cupertino, CA (US)

(72) Inventors: Gregory B. ARNDT, San Jose, CA (US); Mark J. BEESLEY, Carmel Valley, CA (US); Quan QI, San Jose, CA (US)

(21) Appl. No.: 18/420,675

(22) Filed: Jan. 23, 2024

Related U.S. Application Data
(60) Provisional application No. 63/452,122, filed on Mar. 14, 2023.

(51) Int. Cl. H04R 1/08

(52) U.S. Cl. CPC H04R 1/083; H04R 2499/11

(57) ABSTRACT

An apparatus of the subject technology includes a substrate, including a hole, and a vent structure embedded within the substrate to allow air flow through the hole. The substrate is a multi-layer substrate, and the vent structure includes an air-permeable membrane to prevent liquid penetration.

### CROSS-REFERENCE TO RELATED APPLICATION(S)

This application claims the benefit of U.S. Provisional Application Ser. No. 63/452,122, entitled “EMBEDDED WATERPROOF MEMBRANE,” and filed on Mar. 14, 2023, the disclosure of which is expressly incorporated by reference herein in its entirety.

### TECHNICAL FIELD

The present description relates generally to electronic devices, for example, to an electronic device with embedded waterproof membrane.

### BACKGROUND

Electronic devices, including hand-held electronic devices such as smartphones and smartwatches, include transducers, for example, a pressure sensor (for measuring elevation), a gas sensor, and/or a microphone. The transducers are attached to a printed circuit board (PCB), or a flexible PCB (flex). For the electronic device to be waterproof, or protected against penetration of liquids (e.g., water, oil, sweat, or other liquids), the PCB or the flex have to prevent liquids from reaching the transducer, while allowing the flow of air, and acoustic waves.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 is a high-level diagram illustrating an example of a system within which certain aspects of the subject technology are implemented.

FIG. 2 is a diagram illustrating an example of an apparatus embedding a vent structure according to one or more implementations of the subject technology.

FIG. 3 is a schematic diagram illustrating an example of vent structure, according to one or more implementations of the subject technology.

FIGS. 4A, 4B, and 4C are flow diagrams illustrating examples of a process for fabricating a substrate embedding the vent structure of FIG. 3, according to one or more implementations of the subject technology.

FIG. 5 is a schematic diagram illustrating an example of an electronic device within which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In some aspects, the subject technology is directed to an electronic device with an embedded waterproof membrane. In some embodiments, an apparatus of the subject technology includes a substrate, including a hole, and a vent structure embedded within the substrate to allow air flow through the hole. The substrate is a multi-layer substrate, and the vent structure includes an air-permeable membrane to prevent liquid penetration.

The subject technology modifies an existing solution by embedding the vent structure within the substrate to achieve the same result with a reduced number of layers, as shown and discussed herein. The apparatus of the subject technology has a thinner substrate and is less complex and more cost effective than the existing solution.

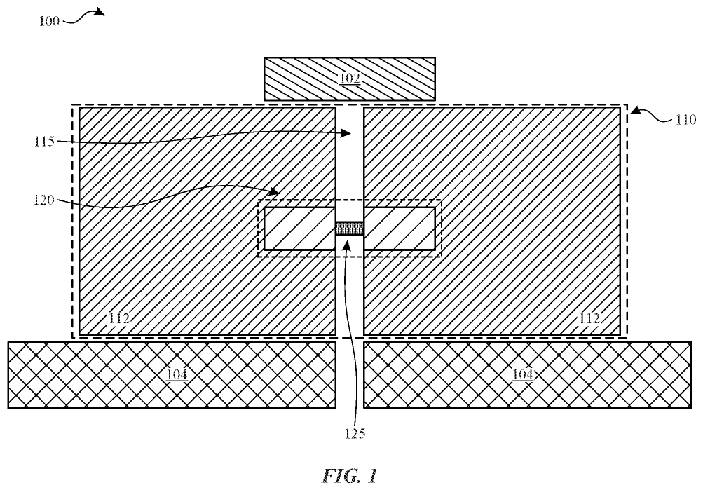

FIG. 1 is a high-level diagram illustrating an example of a system 100 within which certain aspects of the subject technology are implemented. In some embodiments, the system 100 is part of an electronic device such as a smartphone, a smartwatch, or similar devices. The system 100 includes a transducer 102, a housing 104, and a substrate 110 including a multiple layer 112, and an embedded vent structure 120. The vent structure 120 is also referred to as a membrane structure. In some embodiments, the substrate 110 is a multilayer flexible substrate. The substrate 110 includes a hole 115 which passes through the multiple layer 112, and the embedded vent structure 120, except for a membrane 125 of the vent structure 120. In some embodiments, the transducer 102 is a sensor, including, but not limited to, a gas sensor, or a pressure sensor. In some embodiments, the transducer 102 is a microphone. The hole 115 extends through the housing 104, and allows the air (e.g., including one or more gases) to flow from a surrounding environment to the transducer 102 (e.g., a sensor), and/or sound waves to reach the microphone.

In some embodiments, the electronic device (e.g., a smartphone, or a smartwatch) is used in an aquatic environment such as a pool, lake, river, or other aquatic environment. The membrane 125 is a waterproof and air-permeable membrane that allows the air (e.g., including one or more gases) or sound waves to pass through, while preventing liquid penetration, to protect the transducer 102 from intruding liquids such as water, oil, sweat, or other liquids.

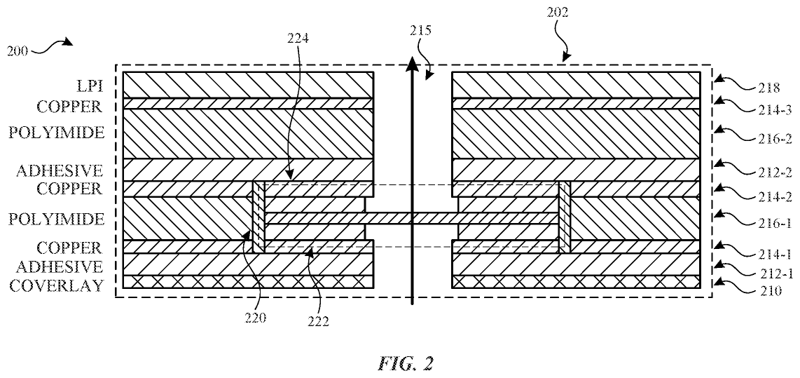

FIG. 2 is diagrams illustrating an example of an apparatus 200 embedding a vent structure according to one or more implementations of the subject technology. In some embodiments, the apparatus 200 includes a substrate 202, including a hole 215, and a vent structure 214 embedded within the substrate 202, configured to allow (facilitate) air flow through the hole 215. In some embodiments, the substrate 202 is a multi-layer substrate. In some embodiments, the substrate 202 is a PCB, or a flexible substrate such as a flexible PCB. In some embodiments, the vent structure 214 includes a membrane that allows air flow and prevents liquid penetration from reaching the transducer (e.g., 102 of FIG. 1) through the hole 215 of the substrate. The hole 215 allows the air flow to reach a sensor (e.g., 102 of FIG. 1) attached to the substrate, or a sound wave to reach a microphone attached to the substrate.

In some embodiments, multi-layer substrate includes a first group of layers, and a second group of layers, formed, respectively, on a first surface, and a second surface of the vent structure. In some embodiments, the first surface is the surface of the first conductive layer 224-1, and the second surface is the surface of the second conductive layer 224-2. In some embodiments, the first conductive layer 224-1 and the second conductive layer 224-2 can be made of a conductive metal, such as copper, silver, tungsten, or other conductive materials. The first group of layers includes the first conductive layer 224-1 adhered to a protective layer 238 by a first bonding layer 228-1 (e.g., an adhesive, such as an epoxy). In some embodiments, the protective layer is a cover layer known as “coverlay”, which consists of a solid sheet of polyimide with a layer of flexible adhesive. Coverlay plays the exact same function as a solder mask on rigid boards, but is only used for flexible PCBs.

The second group of layers includes the second conductive layer 224-2, a second bonding layer 228-2 (e.g., an adhesive, such as an epoxy), a second polyimide layer 226-3, and a third liquid photo-imageable (LPE) layer 222. The vent structure 214 is formed within a polyimide layer 226-1, which surrounds the vent structure 214.

The existing technique of including a vent introduces additional layers of auxiliary structure, which makes the resulting substrate thicker, more complex, and costlier. The subject technology embeds a venting structure (e.g., venting structure 214) to achieve the same result with a reduced number of layers, as shown and discussed above regarding FIG. 2.

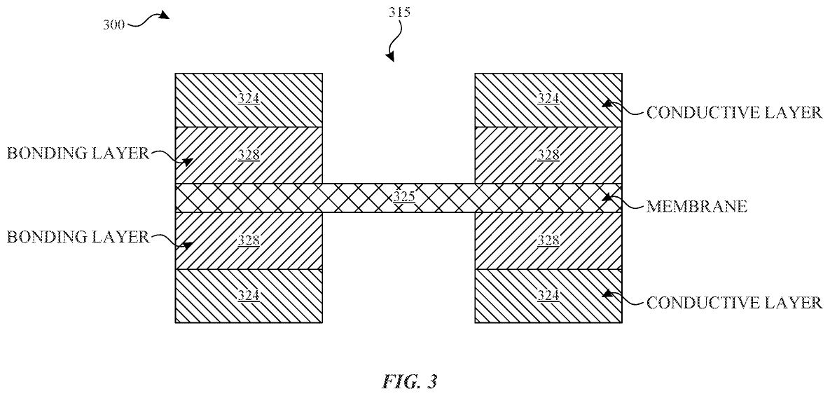

FIG. 3 is a schematic diagram illustrating an example of vent structure 300, according to one or more implementations of the subject technology. The vent structure 300 shows an implementation of the vent structure 214 embedded in the substrate 202 of FIG. A. In some embodiments, the vent structure 300 includes a membrane 325 coupled via bonding layers 328 to conductive layers 324. The conductive layers 324 (e.g., copper) are adhered to two surfaces of the membrane 325, excluding a region within a hole 315. The membrane 325 is a waterproof and air-permeable membrane that allows flow of air, gas, or sound waves through the hole 315, and prevents liquids, such as water, oils, sweat, or other liquids to penetrate through it.

In some embodiments, the membrane 325 is made of an open-pore fluoropolymer layer. In some embodiments, the membrane 325 is made of a layer of expanded polytetrafluoroethylene (ePTFE). The ePTFE grafts are made by the extrusion of PTFE resin mixed with a lubricant. The microporous structure of ePTFE is obtained by a process that involves the rapid stretching of the extruded tube at a high temperature.

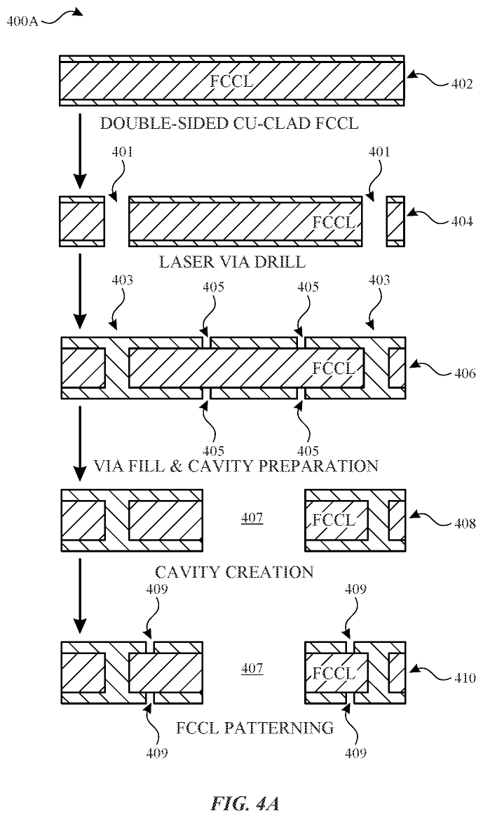

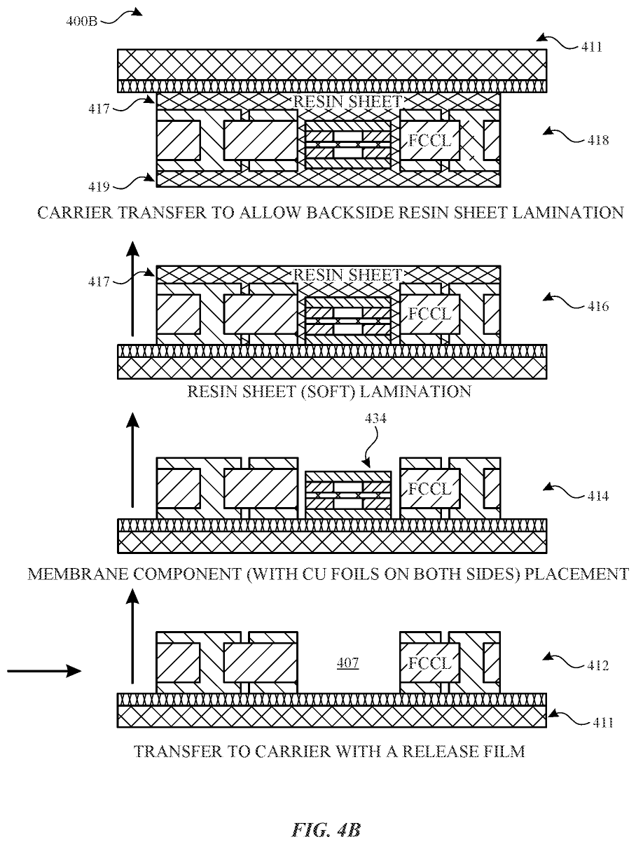

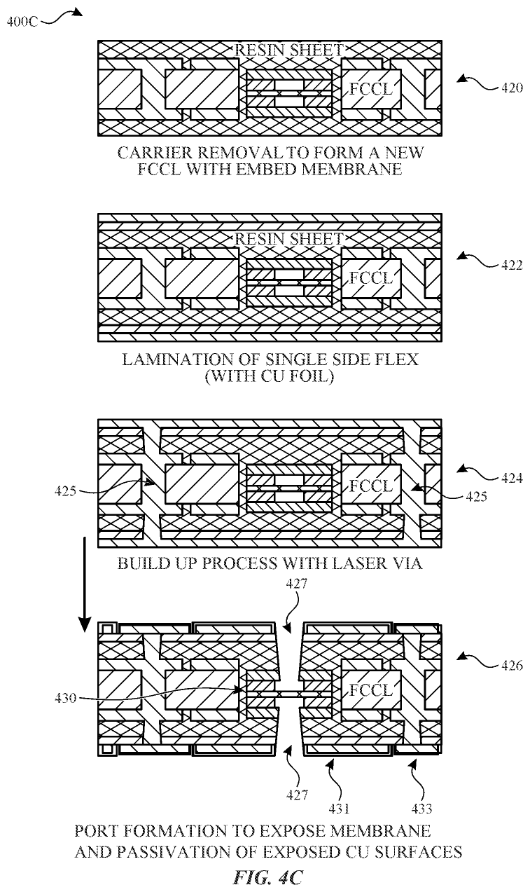

FIGS. 4A, 4B, and 4C are flow diagrams 400A, 400B, and 400C illustrating an example of a process for fabricating a substrate, and embedding the vent structure of FIG. 3, according to one or more implementations of the subject technology. The flow diagrams 400A, 400B, and 400C are successive flow charts, collectively showing steps of the process for fabricating a substrate and embedding the vent structure into a substrate. The process of flow diagram 400A includes steps 402, 404, 406, 408, and 410. The process of flow diagram 400A begins with the step 402, where a flexible copper-clad laminate (FCCL) is prepared as the starting layer. The FCCL is a flexible laminate that is widely used in the semiconductor industry. At the step 404, laser drilling is used to make holes 401 that penetrate the entire thickness of the FCCL. At the step 406, the holes 401 are filled with a conductive material, such as copper, to form vias, and patterning is used to create marks 405 for the next step to be created on two (both) sides of the FCCL. At the step 408, the marks 405 are utilized to create a cavity 407 within the FCCL. At the step 410, the product of step 408 is patterned to create marks 409 on both sides of the FCCL.

The process of flow diagram 400B includes steps 412, 414, 416, and 418. The process of flow diagram 400B starts with the step 412, which follows the step 410, where a release film is used to transfer the product of step 410 onto a carrier 411. At the step 414, membrane component 434 (e.g., vent structure 300 of FIG. 3), with copper foil on both sides, is placed in the cavity 407. At the step 416, a soft lamination 417 (e.g., a resin) is used to cover the product of step 414, including filling the markings 409, and the space around the membrane component 434. At the step 418, the carrier 411 is transferred to the other surface of the product of the step 416, and a soft lamination 419 (e.g., a resin) is used to fill other markings 409, and the remaining space around the membrane component 434, as shown in FIG. 4B.

The process of flow diagram 400C includes steps 420, 422, 424, and 426. The process of flow diagram 400C starts with the step 420, which follows the step 418, and is where the carrier 411 is removed from the product of the step 418. At the step 422, both sides of the product of the step 420 are laminated with a single-side flex, which is similar to the FCCL but has a copper layer on one side. At the step 424, using laser drilling, holes for vias 425 are made, and the holes are filled with a conducting material, such as copper, to build up the vias. Finally, at the step 424, a laser-chemical process is used to open up a port 427 to expose membrane 430, and the surfaces are passivated using a coverlay 431 and a surface finish layer 433, as shown in FIG. 4C. In some embodiments, the conduction material mentioned in the description of the flow diagrams 400A, 400B, and 400C are not limited to copper, and other suitable conducting materials, such as silver, tungsten, or other conducting materials, can be used.

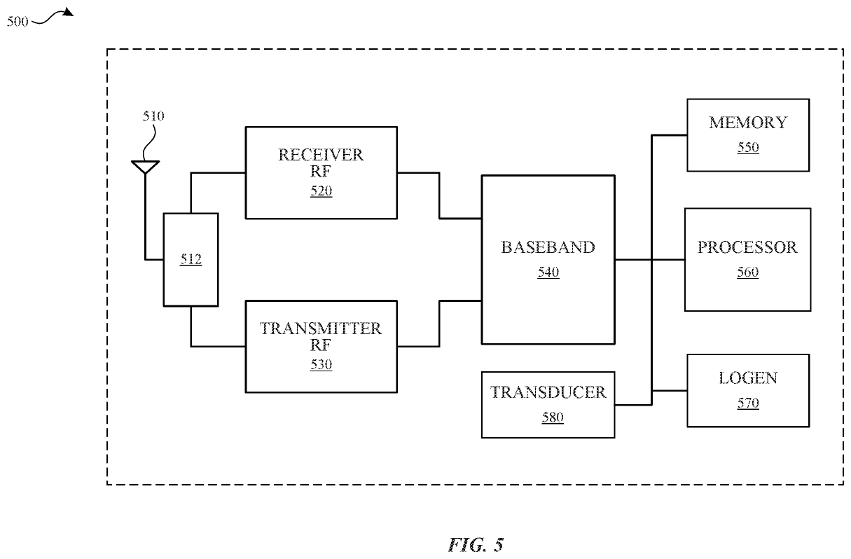

FIG. 5 is a schematic diagram illustrating an example of an electronic device 500 within which aspects of the subject technology may be implemented. In some aspects, the electronic device 500 may represent a communication device (e.g., a smartphone, or smartwatch), a tablet, a laptop, or any other electronic device. The electronic device 500 may comprise a radio frequency (RF) antenna 510, a receiver 520, a transmitter 530, a baseband processing module 540, a memory 550, a processor 560, a local oscillator generator (LOGEN) 570, and a transducer 580. In various embodiments of the subject technology, one or more of the blocks represented in FIG. 5 may be integrated on one or more semiconductor substrates. The blocks 520-570, for example, may be realized on a single chip, a single system on a chip, or on a multi-chip chipset.

The RF antenna 510 may be suitable for transmitting and/or receiving RF signals (e.g., wireless signals) over a wide range of frequencies. Although a single RF antenna 510 is illustrated, the subject technology is not so limited.

The receiver 520 may comprise suitable logic circuitry and/or code that may be operable to receive, and process signals from the RF antenna 510. The receiver 520 may, for example, be operable to amplify, and/or down-convert received wireless signals. In various embodiments of the subject technology, the receiver 520 may be operable to cancel noise in received signals and may be linear over a wide range of frequencies. In this manner, the receiver 520 may be suitable for receiving signals in accordance with a variety of wireless standards, including Wi-Fi, WiMAX, Bluetooth, and other various cellular standards. In various embodiments of the subject technology, the receiver 520 may not require any SAW filters, and few or no off-chip discrete components, such as large capacitors, and inductors.

The transmitter 530 may comprise suitable logic circuitry and/or code that may be operable to process and transmit signals from the RF antenna 510. The transmitter 530 may, for example, be operable to up-convert baseband signals to RF signals and amplify RF signals. In various embodiments of the subject technology, the transmitter 530 may be operable to up-convert and amplify baseband signals processed in accordance with a variety of wireless standards. Examples of such standards may include Wi-Fi, WiMAX, Bluetooth, and other various cellular standards. In various embodiments of the subject technology, the transmitter 530 may be operable to provide signals for further amplification by one or more power amplifiers.

The duplexer 512 may provide isolation in the transmit band to avoid saturation of the receiver 520, damaging parts of the receiver 520, and/or to relax one or more design requirements of the receiver 520. Furthermore, the duplexer 512 may attenuate the noise in the receive band. The duplexer may be operable in multiple frequency bands for various wireless standards.

The baseband processing module 540 may comprise suitable logic, circuitry, interfaces, and/or code that may be operable to perform processing of baseband signals. The baseband processing module 540 may, for example, analyze received signals, generate control, and/or feedback signals for configuring various components of the electronic device 500, such as the receiver 520. The baseband processing module 540 may be operable to encode, decode, transcode, modulate, demodulate, encrypt, decrypt, scramble, descramble, and/or otherwise process data in accordance with one or more wireless standards. In some implementations, the baseband processing module 540 may include an intelligent boot circuit and perform the functionalities of the intelligent boot of the subject technology, as described above.

The processor 560 may comprise suitable logic, circuitry, and/or code that may enable processing data, and/or controlling operations of the electronic device 500. In this regard, the processor 560 may be enabled to provide control signals to various other portions of the electronic device 500. The processor 560 may also control transfers of data between various portions of the electronic device 500. Additionally, the processor 560 may enable the implementation of an operating system, or otherwise execute code to manage the operations of the electronic device 500. In some implementations, the processor 560 may replace or execute some or all of the functionalities of the processor 320 of FIG. 3 as described above with respect to FIG. 3.

The memory 550 may comprise suitable logic, circuitry, and/or code that may enable the storage of various types of information, such as received data, generated data, code, and/or configuration information. The memory 550 may comprise, for example, RAM, ROM, flash, and/or magnetic storage. In various embodiments of the subject technology, information stored in the memory 550 may be utilized for configuring the receiver 520, and/or the baseband processing module 540.

The local oscillator generator (LOGEN) 570 may comprise suitable logic, circuitry, interfaces, and/or code that may be operable to generate one or more oscillating signals of one or more frequencies. The LOGEN 570 may be operable to generate digital, and/or analog signals. In this manner, the LOGEN 570 may be operable to generate one or more clock signals, and/or sinusoidal signals. Characteristics of the oscillating signals, such as the frequency and the duty cycle, may be determined based on one or more control signals from, for example, the processor 560, and/or the baseband processing module 540.

In operation, the processor 560 may configure the various components of the electronic device 500 based on a wireless standard according to which it is desired to receive signals. Wireless signals may be received via the RF antenna 510, and amplified and down converted by the receiver 520. The baseband processing module 540 may perform noise estimation and/or noise cancellation, decoding, and/or demodulation of the baseband signals. In this manner, information in the received signal may be recovered, and utilized appropriately. For example, the information may be audio and/or video to be presented to a user of the electronic device, data to be stored in the memory 550, and/or information affecting and/or enabling the operation of the electronic device 500. The baseband processing module 540 may modulate, encode, and perform other processing on audio, video, and/or control signals to be transmitted by the transmitter 530 in accordance with various wireless standards.

In some implementations, the transducer 580 may be attached to a PCB or flex embedding a vent structure (e.g., 300 of FIG. 3) as shown in FIG. 2. Using the embedded vent structure of the subject technology would result in a number of benefits, including lower cost, and less thickness of the PCB or the flex.

As used herein, the phrase “at least one of” preceding a series of items, with the terms “and,” or “or” to separate any of the items, modifies the list as a whole rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C,” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but rather are intended to be used interchangeably. In one or more implementations, a processor configured to monitor and control an operation, or a component, may also mean the processor being programmed to monitor and control the operation, or the processor, being operable to monitor and control the operation. Likewise, a processor configured to execute code can be construed as a processor programmed to execute code, or operable to execute code.

Phrases such as “an aspect,” “the aspect,” “another aspect,” “some aspects,” “one or more aspects,” “an implementation,” “the implementation,” “another implementation,” “some implementations,” “one or more implementations,” “an embodiment,” “the embodiment,” “another embodiment,” “a configuration,” “the configuration,” “another configuration,” “some configurations,” “one or more configurations,” “the subject technology,” “the disclosure,” “the present disclosure,” or any other variations thereof and alike are for convenience, and do not imply that a disclosure relating to such phrase(s) is essential to the subject technology, or that such disclosure applies to all configurations of the subject technology. A disclosure relating to such phrase(s) may apply to all configurations, or to one or more configurations. A disclosure relating to such phrase(s) may provide one or more examples. A phrase such as “an aspect,” “or some aspects,” may refer to one or more aspects and vice versa, and this applies similarly to other foregoing phrases.

The word “exemplary” is used herein to mean “serving as an example, instance, or illustration.” Any embodiment described herein as “exemplary,” or as an “example,” is not necessarily to be construed as preferred or advantageous over other implementations. Furthermore, to the extent that the terms “include,” “have,” or the like are used in the description or the claims, such terms are intended to be inclusive in a manner similar to the term “comprise,” as “comprise” is interpreted when employed as a transitional word in a claim.

All structural and functional equivalents to the elements of the various aspects described throughout this disclosure that are known, or later come to be known, to those of ordinary skill in the art are expressly incorporated herein by reference, and are intended to be encompassed by the claims. Moreover, nothing disclosed herein is intended to be dedicated to the public, regardless of whether such disclosure is explicitly recited in the claims. No claim element is to be construed under the provisions of 35 U.S.C. § 112(f) unless the element is expressly recited using the phrase “means for,” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one,” unless specifically so stated, but rather “one or more.” Unless specifically stated otherwise, the term “some” refers to one or more. Pronouns in the masculine (e.g., his), include the feminine and neutral genders (e.g., her, and its), and vice versa. Headings and subheadings, if any, are used for convenience only, and do not limit the subject disclosure.

What is claimed is:

1. An apparatus, comprising:
a substrate including a hole; and
a vent structure embedded within the substrate, and configured to allow air flow through the hole,
wherein:
the substrate comprises a multi-layer substrate, and
the vent structure includes an air-permeable membrane configured to prevent liquid penetration.

2. The apparatus of claim 1, wherein the air-permeable membrane comprises an open-pore fluoropolymer layer.

3. The apparatus of claim 1, wherein the air-permeable membrane comprises a layer made of expanded polytetrafluoroethylene (ePTFE).

4. The apparatus of claim 1, wherein the vent structure further includes conductive layers adhered to two surfaces of the air-permeable membrane, excluding a region within the hole.

5. The apparatus of claim 1, wherein the substrate comprises a printed circuit board (PCB).

6. The apparatus of claim 1, wherein the substrate comprises a flexible substrate, including a flexible PCB.

7. The apparatus of claim 1, wherein the multi-layer substrate includes a first group of layers and a second group of layers formed, respectively, on a first surface and a second surface of the vent structure.

8. The apparatus of claim 7, wherein the first group of layers includes a conductive layer adhered to a protective layer, wherein the protective layer comprises a coverlay.

9. The apparatus of claim 7, wherein the second group of layers includes conductive layers, a polyimide layer, and a liquid photo-imageable (LPE) layer.

10. The apparatus of claim 8, wherein the vent structure is formed within a polyimide layer surrounding the vent structure.

11. The apparatus of claim 9, wherein the hole is configured to allow the air flow to reach a sensor attached to the substrate, or a sound wave to reach a microphone attached to the substrate.

12. An electronic device comprising:
a printed circuit board (PCB) including a hole; and
a membrane structure embedded within the PCB and configured to facilitate air flow through the hole to reach a transducer attached to the PCB,
wherein the membrane structure includes a membrane configured to prevent liquids from reaching the transducer.

13. The electronic device of claim 12, wherein the membrane structure comprises membrane made of expanded polytetrafluoroethylene (ePTFE).

14. The electronic device of claim 12, wherein the membrane structure further includes conductive layers adhered to two surfaces of the membrane, excluding a region within the hole.

15. The electronic device of claim 12, wherein the PCB includes a first group of layers, and a second group of layers formed, respectively, on a first surface, and a second surface of the membrane, excluding a region within the hole.

16. The electronic device of claim 15, wherein the first group of layers includes a conductive layer adhered to a protective layer, wherein the protective layer comprises a coverlay.

17. The electronic device of claim 15, wherein the second group of layers includes conductive layers, a polyimide layer, and a liquid photo-imageable (LPE) layer.

18. The electronic device of claim 12, wherein the transducer comprises one of a gas sensor, a pressure sensor, or a microphone.

19. An apparatus, comprising:
a substrate including a vent structure embedded in the substrate; and
a transducer attached to the substrate,
wherein:
the substrate is a multi-layer flexible substrate, and
the vent structure includes a membrane configured to allow air flow and prevent liquid penetration to reach the transducer through a hole of the substrate.

20. The apparatus of claim 19, wherein:
the membrane comprises an air-permeable and water-proof membrane made of expanded polytetrafluoroethylene (ePTFE),
the vent structure further includes conductive layers covering two surfaces of the membrane, excluding a region within the hole,
the multi-layer flexible substrate includes a first group of layers, and a second group of layers formed, respectively, on a first surface and a second surface of the vent structure,
the first group of layers includes a conductive layer adhered to a protective layer, wherein the protective layer comprises a coverlay, and
the second group of layers includes conductive layers, a polyimide layer, and a liquid photo-imageable (LPE) layer.
